(19) United States
(12) Patent Application Publication
(10) Pub. No.: US 2026/0185651 A1
(43) Pub. Date: Jul. 2, 2026

(54) BALL AND SOCKET MOUNT WITH PERMANENT BALL LOCKING

(71) Applicant: Disney Enterprises, Inc., Burbank, CA (US)

(72) Inventor: Richard H. KIRCHHOFF, Anaheim, CA (US)

(73) Assignee: Disney Enterprises, Inc., Burbank, CA (US)

(21) Appl. No.: 19/007,466

(22) Filed: Dec. 31, 2024

(51) Int. Cl. F16M 11/14

(52) U.S. Cl. CPC F16M 11/14; F16M 2200/022

(57) ABSTRACT

In some implementations, an assembly may comprise a ball comprising one or more first channels provided on an outer surface of the ball. The assembly may further comprise a material configured to harden or cure within a threshold amount of time. The assembly may further comprise a socket configured to receive the ball in an opening defined by an inner surface of the socket. The socket may comprise one or more second channels provided on the inner surface of the socket and an injection port configured to receive the material and distribute the material to the one or more first channels and the one or more second channels. After the material hardens or cures within the threshold amount of time, the ball may be permanently secured within the socket.

### BACKGROUND

A mount is hardware that may be used to fix different objects to a structure. A ball and socket mount enables an object that is fixed to a structure to be moved in multiple directions.

### SUMMARY

In some implementations, a ball and socket mount comprises a ball comprising one or more first channels provided on an outer surface of the ball; and a socket configured to receive the ball in an opening defined by an inner surface of the socket, the socket comprising one or more second channels provided on the inner surface of the socket and an injection port configured to receive a material and distribute the material to the one or more first channels and the one or more second channels, wherein the material is configured to harden or cure within a threshold amount of time to permanently secure the ball within the socket.

In some implementations, an assembly comprises a ball comprising one or more first channels provided on an outer surface of the ball; a material configured to harden or cure within a threshold amount of time; and a socket configured to receive the ball in an opening defined by an inner surface of the socket, the socket comprising one or more second channels provided on the inner surface of the socket and an injection port configured to receive the material and distribute the material to the one or more first channels and the one or more second channels, wherein after the material hardens or cures within the threshold amount of time, the ball is permanently secured within the socket.

In some implementations, a method comprises providing a ball in an opening defined by an inner surface of a socket, the ball comprising one or more first channels provided on an outer surface of the ball, and the socket comprising an injection port and one or more second channels provided on the inner surface of the socket; providing a material through the injection port, the material configured to harden or cure within a threshold amount of time; and distributing the material to the one or more first channels and the one or more second channels, wherein when the material hardens or cures, the ball is permanently secured within the opening of the socket.

### BRIEF DESCRIPTION OF THE DRAWINGS

FIG. 1 is a diagram of a perspective view of an example ball and socket mount described herein.

FIG. 2 is a diagram of a side view of an example ball assembly described herein.

FIG. 3 is a diagram of a cross-sectional view of an example socket described herein.

FIG. 4 is a diagram of an example implementation of using an example ball and socket mount described herein.

FIG. 5 is a flowchart of an example process relating to using an example ball and socket mount described herein.

### DETAILED DESCRIPTION

The following detailed description of example implementations refers to the accompanying drawings. The same reference numbers in different drawings may identify the same or similar elements.

A ball and socket mount enables an object to be fixed to a structure, such as a wall. The ball and socket mount may enable movement of the object in different directions. Typically, after the ball and socket mount has been used to fix the object to the structure, the ball and socket mount may enable the object to be positioned in a selected position and orientation.

After the object has been positioned in the selected position and orientation, the ball and socket mount may be used to maintain (or secure) the object in the selected position and orientation. In some situations, the ball and socket mount may include a locking mechanism to lock the object in the selected position and orientation. The locking mechanism may be used for a permanent installation of the object. In some situations, additionally, or alternatively to the locking mechanism, custom made brackets may be used to maintain the object in the selected position and orientation.

In some situations, after using the ball and socket mount for permanent installation of the object, the object may be unintentionally bumped or moved. As a result, the object may be subjected to misalignment (e.g., with respect to the selected position). In other words, as a result of the object being unintentionally bumped or moved, the object may no longer be positioned in the selected position.

In some situations, moving the object back to the selected position may be a time consuming task involving reconfiguration of the ball and socket mount. For example, the task may involve unlocking the locking mechanism, repositioning the locking mechanism, and relocking the locking mechanism to permanently maintain or temporarily maintain (e.g., for a desired amount of time) the object in the selected position and orientation.

Implementations described herein are directed to a ball and socket mount with channels for receiving a material in a liquid state that cures and/or hardens. The material may harden within a threshold amount of time without being exposed to air. In some examples, the material may include, glue, among other examples. In this regard, the material may be used to lock (e.g., permanently) the ball in a selected position and orientation.

One advantage of the ball and socket mount described herein is that the material may prevent the ball from being repositioned. Locking (e.g., permanently) of the ball and socket mount, as described herein, may be beneficial in certain situations to prevent individuals from attempting to adjust a position of an object fixed by the ball and socket mount, unintentionally moving the object fixed by the ball and socket mount, and/or attempting to remove the object fixed by the ball and socket mount.

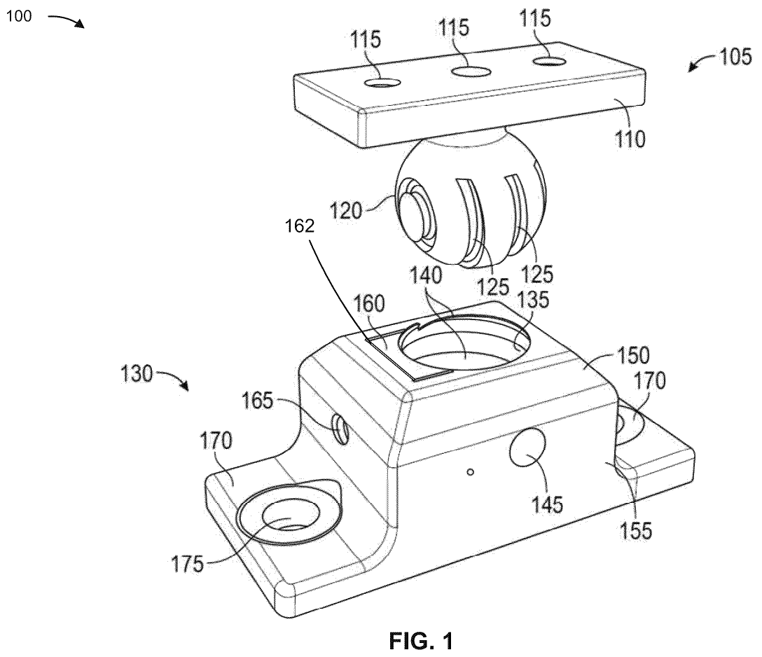

FIG. 1 is a diagram of a perspective view of an example ball and socket mount 100 described herein. Ball and socket mount 100 may be used to fix an object (not in shown in FIG. 1) to a structure (not in shown in FIG. 1) as described herein. As shown in FIG. 1, ball and socket mount 100 may include a ball assembly 105. In some examples, ball assembly 105 may include a metal material. In some examples, ball assembly 105 may include a plastic material.

As shown in FIG. 1, ball assembly 105 may include a coupling component 110. Coupling component 110 may be used to connect ball assembly 105 to the object. As shown in FIG. 1, coupling component 110 may include one or more openings 115 to facilitate mounting to the object. The openings 115 may be defined by inner surfaces extending from a top surface of the ball assembly 105 to a bottom surface of the ball assembly 105. An opening 115 may receive a fastener to connect an object to ball assembly 105. In some examples, the fastener may include a bolt, a screw, a through bolt, among other examples. In this regard, the inner surfaces of the opening 115 may be threaded. Although the example of FIG. 1 illustrates three openings 115, in other examples, the coupling component 110 may include a different number of openings 115 (e.g., one opening, two openings, or more than three openings). In some situations, the coupling component 110 may be provided without an opening 115. In this regard, the coupling component 110 may be coupled to the object using a contact-based material, such as resin, welding metals, or other adhesive.

As shown in FIG. 1, ball assembly 105 may include a ball 120 having one or more first channels 125 provided in an outer surface thereof. Ball 120 may be shaped as a generally spherical volume of material with the one or more first channels 125. In some aspects, the ball 120 may include an oblong or irregular ellipsoid with the one or more first channels 125. One or more first channels 125 may be etched, engraved, inserted in an injection molding process, or otherwise provided on the outer surface of ball 120 (e.g., provided as recesses). One or more first channels 125 are configured to receive a material in a liquid state that cures and/or hardens within a threshold amount of time (e.g., cures or hardens in 24 hours or less, 72 hours or less, a week or less, or any other selected threshold amount of time) without being exposed to air. In some examples, the material may include a resin, such as epoxy, glue, among other examples. Although hereinafter an example in which the material is a resin will be described, another material may be used as long as the material can cure and/or harden within the threshold amount of time without being exposed to air. One or more first channels 125 are configured to receive the resin provided to ball and socket mount 100 after ball 120 has been provided in a selected position and orientation.

As shown in FIG. 1, ball and socket mount 100 may include a socket 130. As shown in FIG. 1, socket 130 may include an inner surface 135 defining an opening configured to receive ball 120. In some examples, one or more second channels 140 may be provided on inner surface 135. One or more second channels 140 may be etched, engraved, inserted in an injection molding process, or otherwise provided on inner surface 135 of socket 130. In some examples, one or more second channels 140 may include one or more spiraling channels. One or more second channels 140 may be configured to receive the resin provided to ball and socket mount 100 after ball 120 has been provided in the selected position and orientation. One or more second channels 140 may be provided at a non-zero degree angle with respect to one or more first channels 125 (i.e., one or more first channels 125 and one or more second channels 140 are not parallel). In some examples, one or more second channels 140 and one or more first channels 125 may be non-mating. For instance, one or more second channels 140 may be orthogonal to one or more first channels 125. In some situations, one or more second channels 140 and one or more first channels 125 may be provided at other angles (e.g., angles other than ninety degrees). Providing ball and socket mount 100 with one or more second channels 140 and one or more first channels 125 may increase a surface area of ball 120 in contact with the resin. Additionally, providing one or more second channels 140 and one or more first channels 125 at an angle (e.g., non-mating) may further increase the surface area of ball 120 in contact with the resin. Increasing the surface area of ball 120 in contact with the resin may better secure ball 120 in socket 130. In other words, increasing the surface area of ball 120 in contact with the resin may facilitate locking (e.g., permanently) ball 120 in the selected position and orientation in socket 130. While examples herein may refer to one or more second channels 140 and one or more first channels 125, in some situations, ball and socket mount 100 may include only one or more second channels 140 (i.e., exclude one or more first channels 125) or may include only one or more first channels 125 (i.e., exclude one or more second channels 140).

As shown in FIG. 1, socket 130 may include an injection port 145 that may extend from the inner surface of socket 130 to an outer surface of socket 130. Injection port 145 may receive the resin after ball 120 has been provided in the selected position and orientation within socket 130. For example, the resin may be inserted via injection port 145 (e.g., by injecting, pouring, or otherwise providing the resin in injection port 145 at the outer surface of socket 130 towards the inner surface of socket 130) to lock (e.g., permanently) ball 120 in the selected position and orientation once the resin hardens and/or cures. In other words, the resin may maintain (e.g., permanently) ball 120 in the selected position and orientation. The resin may be provided to one or more first channels 125 and to one or more second channels 140 via injection port 145.

The resin may be provided to one or more first channels 125 and to one or more second channels 140 to secure ball 120 in socket 130 (e.g., after the ball is received in the opening of inner surface 135). As shown in FIG. 1, injection port 145 may be provided between upper portion 150 (including an upper surface of socket 130) of the outer surface of socket 130 and a lower portion 155 (including a lower surface of socket 130) of the outer surface of socket 130. As further shown in FIG. 1, injection port 145 may be provided in a location that enables the resin to be provided to one or more first channels 125 and/or one or more second channels 140. For example, injection port 145 may be aligned with respect to the position of ball 120 (e.g., with respect to a channel of one or more first channels 125) once ball 120 has been inserted into socket 130. In this regard, injection port 145 may be aligned in a manner that enables the resin to be provided to one or more first channels 125 and one or more second channels 140. In some examples, injection port 145 may be at a horizontal orientation. In some examples, injection port 145 may be angled (e.g., may be at an angled orientation) such that a portion of injection port 145 at the outer surface of socket 130 is closer to the upper surface of socket 130 than a portion of injection port 145 at the inner surface of socket 130. As noted above, while examples herein may refer to a resin, other examples may use other materials that cure and/or harden to secure ball 120 in socket 130.

As shown in FIG. 1, socket 130 may include moveable component 160 that is configured to move toward ball 120 until creating contact with ball 120 to create friction with ball 120. Moveable component 160 may be moveably coupled to inner surface 135 of socket 130 such that contact between moveable component 160 and socket 130 causes moveable component 160 to resist force applied in a direction along a longitudinal axis of moveable component 160 (e.g., from inner surface 135 of socket 130 and toward an outer surface of socket 130). The friction may further cause ball 120 to be secured in socket 130. Moveable component 160 may be implemented using a fastener (as explained herein, a spring, a flange, a sliding element, without limitation. As shown in FIG. 1, socket 130 may include a component channel 162. Component channel 162 may be etched, engraved, inserted in an injection molding process, or otherwise provided on socket 130. As explained herein, component channel 162 may extend from upper portion 150 toward lower portion 155. Component channel 162 may delineate a shape of moveable component 160. Component channel 162 may create a separation (or a space) between moveable component 160 and socket 130. The separation (or the space) may enable moveable component 160 to be moved toward ball 120. As shown in FIG. 1, socket 130 may include a moveable component opening 165. Moveable component opening 165 may receive a fastener that moves moveable component 160 toward ball 120. In some implementations, moveable component opening 165 may be threaded. In this regard, the fastener may include a screw (e.g., set screw) or a bolt, without limitation. The fastener may be used to temporarily (or optionally) lock ball 120 within socket 130.

As shown in FIG. 1, socket 130 may include a mounting component 170 that extends (e.g., laterally) from lower portion 155 of socket 130. In other examples, mounting component 170 may extend (e.g., laterally) from another portion of socket 130 (e.g., upper portion 150, a mid-portion, etc.). Mounting component 170 may be mounted to an external structure. As shown in FIG. 1, mounting component 170 may include one or more mounting openings 175 to facilitate mounting to the external structure, such as a wall, furniture (e.g., a table), a dashboard, a post, or any other structure. The mounting openings 175 may be defined by inner extending from a top surface of mounting component 170 to a bottom surface of mounting component 170 (or bottom surface of socket 130). A mounting opening 175 may receive a fastener that couples mounting component 170 to the external structure. In some implementations, mounting openings 175 may be threaded. In this regard, the fastener may include a screw (e.g., set screw) or a bolt, without limitation.

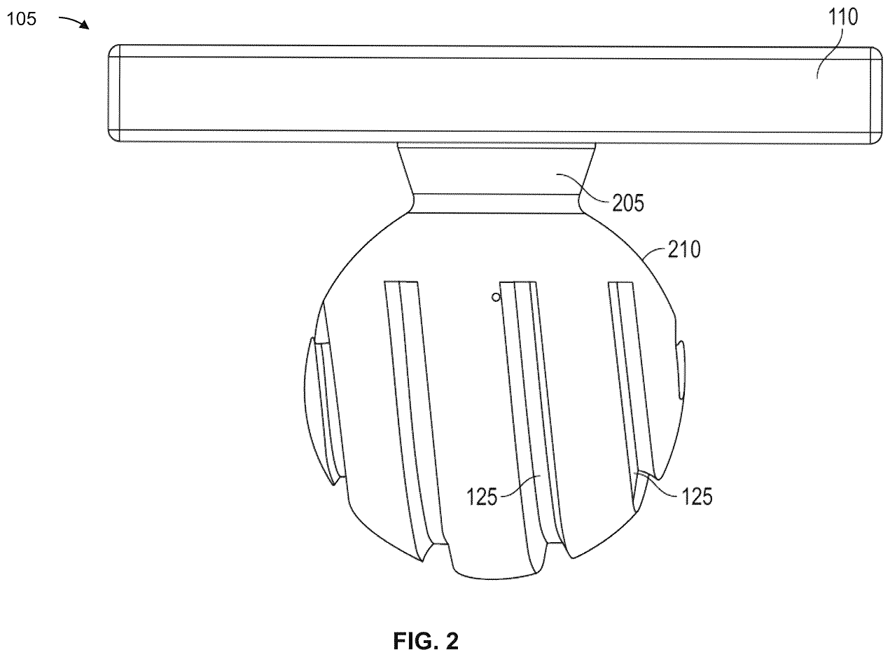

FIG. 2 is a diagram of a side view of an example ball assembly described herein. Elements of ball assembly 105 have been described above in connection with FIG. 1. As shown in FIG. 2, ball assembly 105 may include a protruding component 205 that connects ball 120 to coupling component 110. In other examples, ball 120 may be directly connected to or integrally formed with coupling component 110. As shown in FIG. 2, ball 120 may have a spherical (e.g., generally spherical) shape. In some examples, ball 120 may have an oblong, ellipsoidal, or irregular shape. As shown in FIG. 2, an outer surface 210 of ball 120 may include one or more first channels 125 defined by channel surfaces of outer surface 210 of ball 120. As shown in FIG. 2, one or more first channels 125 may be generally vertical. In some implementations, one or more first channels 125 may generally horizontal instead of generally vertical. In some examples, one or more first channels 125 may be parallel to each other, may be intersecting with each other, may be at an angle with respect to each other, etc. In other examples, one or more first channels 125 may be spiraling channels.

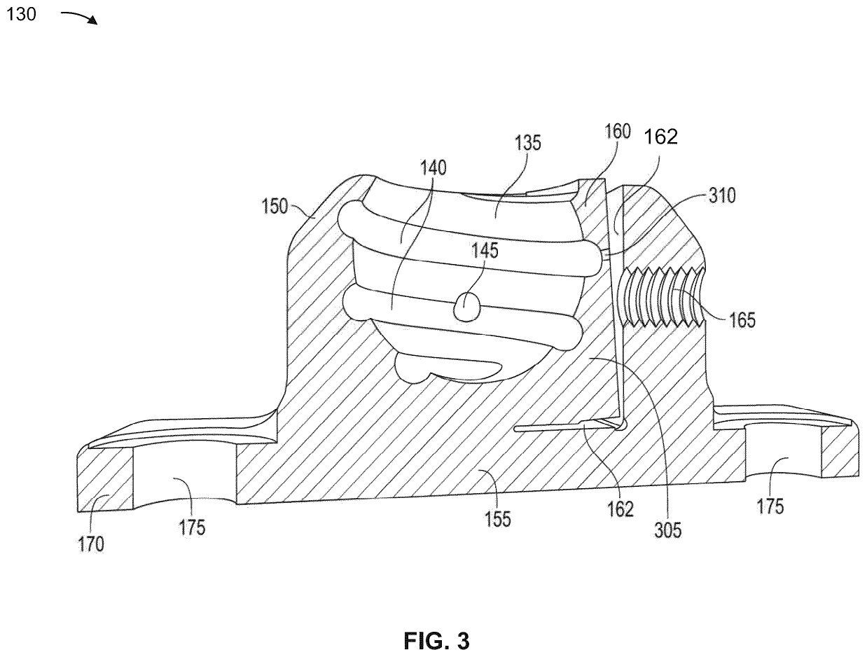

FIG. 3 is a diagram of a cross-sectional view of an example socket described herein. Elements of socket 130 have been described above in connection with FIG. 1 and FIG. 2. As shown in FIG. 3, component channel 162 may extend from upper portion 150 (not shown) toward lower portion 155. Optionally, component channel 162 may additionally extend laterally along lower portion 155. For example, as shown in FIG. 3, component channel 162 may extend partially along lower portion 155. In this regard, a portion of moveable component 160 may be attached (or connected) to socket 130 (e.g., hingedly or flexibly) and a remaining portion of moveable component 160 may be detached (or disconnected) from socket 130. Accordingly, in some examples, the portion of moveable component 160 (attached or connected to socket 130) may be implemented as a living hinge. The portion of moveable component 160 may be attached (or connected) to socket 130 at a connection portion 305. In this regard, as shown in FIG. 3 for example, moveable component 160 may be a flexible component that flexes at connection portion 305. As explained herein, moveable component opening 165 may receive a fastener that moves moveable component 160 (e.g., a flexible component) toward ball 120. As shown in FIG. 3, inner surface 135 of socket 130 may include an overflow channel 310. Overflow channel 310 may extend from one channel of one or more second channels 140 toward a rear surface of moveable component 160. As shown in FIG. 3, overflow channel 310 may extend to component channel 162. In this regard, overflow channel 310 may enable an excess amount of the resin (received by one or more first channels 125 and/or one or more second channels 140) to enter component channel 162, thereby filling a portion of the space created by component channel 162. By filling the portion of the space with the excess amount of the resin, moveable component 160 and inner surface 135 may further secure ball 120. As shown in FIG. 3, moveable component opening 165 may be threaded. Accordingly, in some examples, the fastener received by moveable component opening 165 may be a threaded fastener.

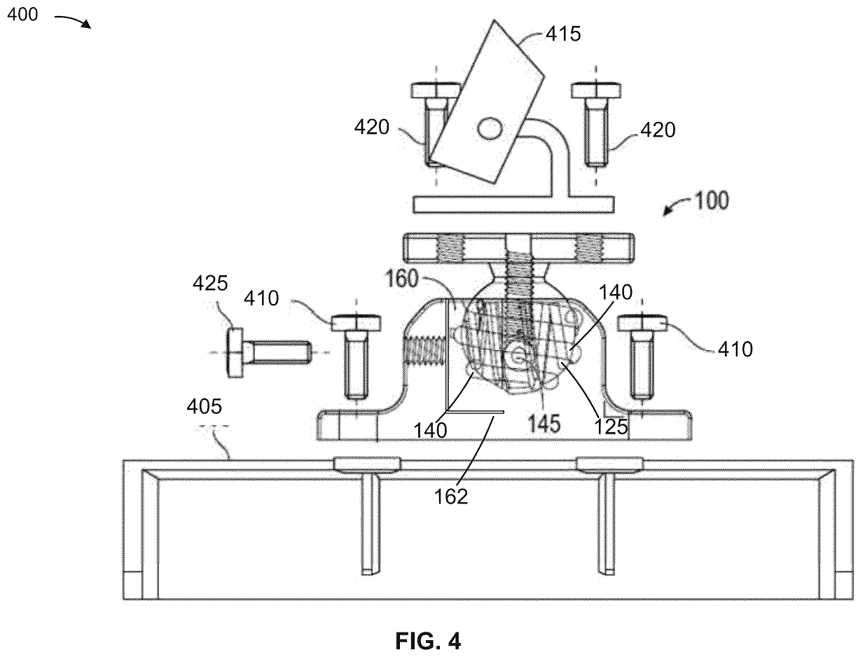

FIG. 4 is a diagram of an example implementation 400 described herein. Elements of ball and socket mount 100 have been described above in connection with FIGS. 1-3. As shown in FIG. 4, implementation 400 may include ball and socket mount 100, a structure 405 to which ball and socket mount will be fixed, socket fasteners 410, an object 415 configured to be fixed to structure 405 via ball and socket mount 100, object fasteners 420, and a moveable component fastener 425. In some implementations, object 415 may include a fan, a light source, a camera, a speaker, a television screen, a computer screen, a painting, or any other object. In some implementations, the structure 405 may include a wall, furniture (e.g., a table), a post, or any other structure. In some implementations, socket fasteners 410, object fasteners 420, and/or moveable component fastener 425 may include screws. Additionally, or alternatively, socket fasteners 410, object fasteners 420, and/or moveable component fasteners 425 may include bolts, screws, or through bolts, among other examples. Although two socket fasteners 410 are illustrated in FIG. 4, in other examples, a different number of socket fasteners 410 may be used (e.g., one socket fastener or more than two socket fasteners). Although two object fasteners 420 are illustrated in FIG. 4, in other examples, a different number of object fasteners 420 may be used (e.g., one object fastener or more than two object fasteners). Although one moveable component fasteners 425 are illustrated in FIG. 4, in other examples, a different number of moveable component fasteners 425 may be used (e.g., more than one moveable component fastener). In some implementations, at least one of socket fasteners 410, object fasteners 420, or moveable component fasteners 425 may be excluded.

In some implementations, ball and socket mount 100 (e.g., socket 130) may be fixed or coupled to structure 405 using socket fasteners 410. Ball 120 may be received in an opening defined by inner surface 135 of socket 130. In some situations, ball 120 may be moved to a selected position and orientation after being received in the opening defined by inner surface 135. In some situations, object 415 may be fixed or coupled to ball and socket mount 100 (e.g., ball assembly 105) using object fasteners 420. Ball 120 may be moved to the selected position and orientation, within the opening defined by inner surface 135, after object 415 has been fixed or coupled to ball and socket mount 100.

In some situations, moveable component fastener 425 may be received by moveable component opening 165. Moveable component fastener 425 may move or bias moveable component 160 toward ball 120 to temporarily lock ball 120 in the selected position and orientation.

After temporarily locking ball 120 in the selected position and orientation, resin (or other liquid material capable of curing or hardening within a threshold time without exposure to air) may be provided through injection port 145. The resin may be provided to one or more first channels 125 and/or one or more second channels 140, and an excess amount of the resin may be provided to overflow channel 310. After the resin transitions from a liquid state to a hardened or cured state, the resin may lock (e.g., permanently) ball 120 in the selected position and orientation. As shown in FIG. 4, one or more second channels 140 and one or more first channels 125 may be provided at an angle (e.g., a non-zero angle). In some examples, one or more second channels 140 may be orthogonal to one or more first channels 125.

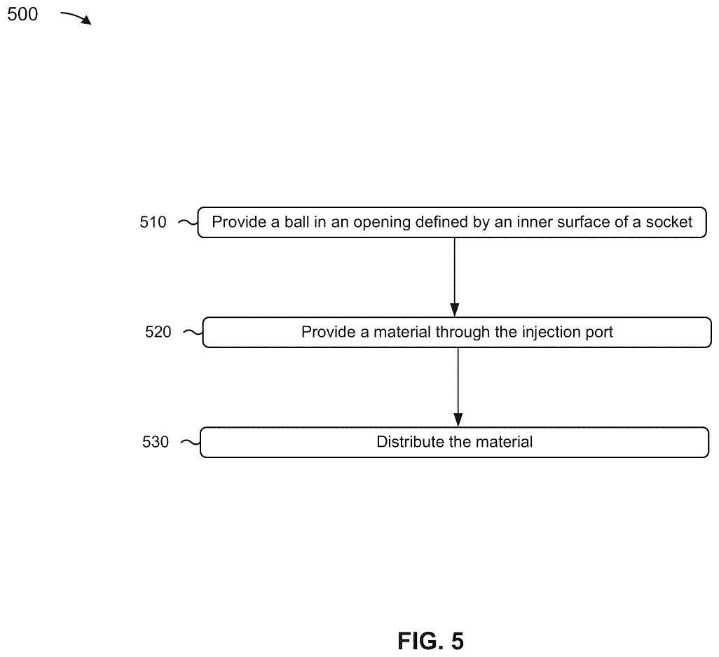

FIG. 5 is a flowchart of an example process 500 relating to using an example ball and socket mount described herein. As shown in FIG. 5, process 500 may include providing a ball in an opening defined by an inner surface of a socket (block 510). In some examples, the ball may comprise one or more first channels provided on an outer surface of the ball. In some examples, the socket may comprise an injection port and one or more second channels provided on an inner surface of the socket. Once received within the socket, the ball maybe rotated, translated, or otherwise moved into a desired position and orientation.

In some examples, the socket may further comprise a moveable component configured to move or bias the ball. In this regard, process 500 may optionally include moving the moveable component toward the ball to temporarily lock the ball in the selected position and orientation. In some examples, the socket may further comprise a moveable component opening. In this regard, moving the moveable component toward the ball may comprise inserting a fastener in the moveable component opening to bias the moveable component toward the ball and further secure the ball within the socket in the selected position and orientation.

In some examples, the ball may be coupled to or integrally formed with a coupling component. An object may be coupled to the coupling component for mounting.

As shown in FIG. 5, after the ball is received in the socket and positioned and oriented as desired, process 500 may include providing a material through the injection port (block 520). In some examples, the material may comprise resin, epoxy or glue. Although the material is inserted in a single point (i.e., the injection port), the material will spread to fill the one or more first channels and the one or more second channels, as described herein. In other words, the injection port may receive and distribute the material to the one or more first channels and the one or more second channels. Once the material hardens or cures after a threshold amount of time has elapsed, the ball may be locked (e.g., permanently) in the selected position and orientation.

In some examples, the ball may be coupled to or integrated with a first side of a coupling component, and the socket may further comprise a mounting component. In this regard, prior to providing the material through the injection port, process 500 may optionally include coupling an object to a second side of the coupling component and mounting the mounting component to a structure. Additionally, process 500 may optionally include moving the ball within the opening of the socket such that the object is mounted to the structure in a selected position and orientation.

As shown in FIG. 5, after providing a material through the injection port, process 500 may include distributing the material (block 530). For example, the material may be distributed to the one or more first channels and the one or more second channels due to gravity and/or pressure exerted as additional material is inserted in the injection port. In some examples, when the material hardens or cures, the ball may be permanently secured within the opening of the socket. For example, once the material hardens or cures after a threshold amount of time has elapsed, the ball may be locked (e.g., permanently) in the selected position and orientation.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “top,” “bottom,” “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A ball and socket mount, comprising:
a ball comprising one or more first channels provided on an outer surface of the ball; and
a socket configured to receive the ball in an opening defined by an inner surface of the socket, the socket comprising one or more second channels provided on the inner surface of the socket and an injection port configured to receive a material and distribute the material to the one or more first channels and the one or more second channels,
wherein the material is configured to harden or cure within a threshold amount of time to permanently secure the ball within the socket.

2. The ball and socket mount of claim 1, wherein the one or more first channels are orthogonal to the one or more second channels when the ball is received in the socket.

3. The ball and socket mount of claim 1, wherein (i) the one or more first channels comprises one or more spiraling channels, (ii) the one or more second channels comprises one or more spiraling channels, or (iii) both the one or more first channels and the one or more second channels comprise spiraling channels.

4. The ball and socket mount of claim 1, wherein the socket further comprises a moveable component configured to move toward the ball received in the socket to create friction between the inner surface of the socket and the ball, and
wherein the friction further causes the ball to be secured in the socket.

5. The ball and socket mount of claim 1, wherein the material comprises a resin, an epoxy, or a glue.

6. The ball and socket mount of claim 1, wherein the injection port is located at a side portion of the socket in a position between an upper surface of the socket and a lower surface of the socket, and
wherein the injection port is aligned with a channel of the one or more first channels when the ball is received in the opening.

7. The ball and socket mount of claim 1, wherein the one or more first channels are not parallel to the one or more second channels when the ball is received in the socket.

8. An assembly comprising:
a ball comprising one or more first channels provided on an outer surface of the ball;
a material configured to harden or cure within a threshold amount of time; and
a socket configured to receive the ball in an opening defined by an inner surface of the socket, the socket comprising one or more second channels provided on the inner surface of the socket and an injection port configured to receive the material and distribute the material to the one or more first channels and the one or more second channels,
wherein after the material hardens or cures within the threshold amount of time, the ball is permanently secured within the socket.

9. The assembly of claim 8, wherein the one or more first channels are not parallel to the one or more second channels when the ball is received in the opening of the socket.

10. The assembly of claim 8, wherein the one or more first channels extend in a first direction, and
wherein the one or more second channels extend in a second direction different from the first direction.

11. The assembly of claim 10, wherein the first direction is substantially orthogonal to the second direction.

12. The assembly of claim 8, wherein the material comprises a resin, an epoxy, or a glue.

13. The assembly of claim 8, wherein the socket further comprises a moveable component configured to move toward the ball to create friction between the inner surface of the socket and the ball, and
wherein the friction further causes the ball to be secured within the socket.

14. The assembly of claim 8, further comprising a coupling component,
wherein the ball is coupled to or integrated with a first side of the coupling component, and a second side of the coupling component is configured to be secured to an object to be mounted using the assembly.

15. The assembly of claim 14, wherein the socket further comprises a mounting component configured to secure the assembly to a structure, thereby mounting the object secured to the coupling component to the structure.

16. A method comprising:
providing a ball in an opening defined by an inner surface of a socket, the ball comprising one or more first channels provided on an outer surface of the ball, and the socket comprising an injection port and one or more second channels provided on the inner surface of the socket;
providing a material through the injection port, the material configured to harden or cure within a threshold amount of time; and
distributing the material to the one or more first channels and the one or more second channels,
wherein when the material hardens or cures, the ball is permanently secured within the opening of the socket.

17. The method of claim 16, further comprising:
moving the ball to a selected position and orientation within the opening of the socket,
wherein the material is provided through the injection port after moving the ball to the selected position and orientation.

18. The method of claim 17, wherein the socket further comprises a moveable component,
wherein the method further comprises moving the moveable component toward the ball to temporarily lock the ball in the selected position and orientation, and
wherein the material is provided through the injection port after moving the moveable component toward the ball.

19. The method of claim 16, wherein the ball is coupled to or integrated with a first side of a coupling component, and the socket further comprises a mounting component,
wherein prior to the providing the material through the injection port, the method further comprises:
coupling an object to a second side of the coupling component;
mounting the mounting component to a structure; and
moving the ball within the opening of the socket such that the object is mounted to the structure in a selected position and orientation, and
wherein when the material hardens or cures, the ball is permanently secured within the opening of the socket to permanently lock the object in the selected position and orientation with respect to the structure.

20. The method of claim 16, wherein the material comprises a resin, an epoxy, or a glue.
